(19) United States
(12) Patent Application Publication
(10) Pub. No.: US 2018/0042709 A1
(43) Pub. Date: Feb. 15, 2018

(54) PREPARATION OF A WAX OR PLASTIC BASE FOR PRODUCING A DENTAL PROSTHESIS

(71) Applicant: Kulzer GmbH, Hanau (DE)

(72) Inventors: Novica Savic, Erlensee (DE); Karl-Heinz Renz, Alzenau (DE); Silke Maren Gall, Alzenau (DE)

(21) Appl. No.: 15/549,182

(22) PCT Filed: Jan. 20, 2016
(86) PCT No.: PCT/EP2016/051082

§ 371 Date: Aug. 7, 2017

(30) Foreign Application Priority Data
Feb. 11, 2015 (DE) 10 2015 101 978.7

(51) Int. Cl. A61C 13/01; A61C 13/10; A61C 13/00; A61C 13/20; A61C 9/00; A61C 13/34

(52) U.S. Cl. CPC A61C 13/01; A61C 9/0046; A61C 13/34; A61C 13/0004; A61C 13/206; A61C 13/1003

(57) ABSTRACT

The invention relates to a method for producing a wax base or a prosthesis base for producing a dental prosthesis, with which a virtual CAD model of the dental prosthesis is used for the production of the physical dental prosthesis or the physical prosthesis base, wherein, from the CAD model of the dental prosthesis, a virtual model of the prosthesis base is calculated, characterized by the following chronological steps:
A) Scanning in of at least one three-dimensional region of a physical model of the oral cavity situation of a patient and preparation of a first data record on the basis of this scan, or
intra-oral scan of a three-dimensional region of the oral cavity situation of the patient and production of a physical model of the oral cavity situation of a patient on the basis of the intra-oral scan and preparation of a first data record on the basis of the intra-oral scan;
B) application of a wax layer or a plastic layer onto the physical model of the oral cavity situation;
D) calculation of a virtual surface as a surface which is to be formed in the wax layer or in the plastic layer, wherein the calculation is made on the basis of the virtual model of the prosthesis base and of the first data record, and wherein positioning aids are provided in the surface which is to be produced, for the positioning of prosthetic teeth; and
E) production of the wax base from the wax layer or of the prosthesis base from the plastic layer with a subtractive CAM method, on the basis of the virtual surface calculated in step D).

The invention also relates to a method for producing a dental prosthesis or a wax set-up for a dental prosthesis, and a prosthesis base, a wax base, or a dental prosthesis, produced with such a method.

The invention relates to a method for preparing a wax base or a prosthesis base for producing a dental prosthesis, with which a virtual CAD model of the dental prosthesis is used for producing the physical dental prosthesis or the physical prosthesis base, wherein, from the CAD model of the dental prosthesis, a virtual model of the prosthesis base is calculated. The invention also relates to a wax base or prosthesis base, a wax set-up, and a dental prosthesis produced with such a method.

The conventional approach is the analog production of dental prostheses. For the production of the prosthesis base, therefore, at the present time in most cases an analog method is used, with which an impression is first taken of the toothless jaw of the patient. From this impression, a gypsum plaster model of the patient situation is prepared. Next, a function model of the prosthesis base made of wax (the wax base) is built up on the gypsum plaster model and fitted with the prosthetic teeth. The wax base is then removed from this set-up, and the set-up of artificial teeth is transferred to a final base made of plastic. For this purpose, a flask is used, as a hollow mold or casting mold, with which the wax base, fitted with prosthetic teeth, is embedded. The wax is washed out of the hardened plaster mold with hot water, such that a cavity is formed for the prosthesis plastic of the prosthesis base. With this process, the prosthetic teeth are already inserted into the hollow mold. The mold is filled or plugged with a gum-colored plastic, and, during the casting process, the prosthetic teeth are connected to the prosthesis base. After the plastic has hardened it undergoes further processing in order to obtain the desired shape.

For the production of the dental prosthesis, in most cases pre-assembled prosthetic teeth are set up manually and individually on the wax base on a plaster model of the toothless jaw. In the next step, this wax prosthesis is embedded into the flask with gypsum, silicone, or gel (depending on the later processing technique), in order then, after the hardening of the embedding material, to release the wax base from the mold in order to create the cavity for the prosthesis plastic. In this situation, the prosthetic teeth remain in the embedding material. An appropriate plastic is injected or cast into the cavity, as a result of which, after the plastic has hardened, the dental prosthesis is obtained. At the setting up of the prosthetic teeth, they are adjusted and ground to match the individual mouth situation of the patient by the dental technician and, as appropriate, also by the dentist.

The whole of such a process is very time-intensive, and therefore cost-intensive, and based on a large number of skilled work steps. In the course of digitalization, the effort in production, setting up, and design of the prosthesis bases and of the prosthetic teeth in relation to the CAD model and the actual production has been taken over by machines (CAM machines).

Digital manufacturing methods are steadily growing in importance in the dental sector. Dental restorations and appliances, such as crowns and bridges, have for some years been manufactured by means of CAD/CAM technologies subtractively with milling techniques (CAM—Computer-Aided Manufacturing, CAD—Computer-Aided Design). The problems surrounding the connection, including the possibility of correction, however, still persist in the convention procedures as well as in the digital techniques.

A CAD/CAM process for manufacturing a dental prosthesis is known from WO 91/07141 A1, wherein, with this process, a prosthesis base based on an impression is milled out of a plastic block (referred to as a round blank). The milled-out prosthesis base is only 2 to 3 mm thick.

A disadvantage is therefore a very high material wastage, which, depending on the anatomical situation of the respective patient, can even amount to more than 90%. As well as this, the milling out of such large quantities of material requires correspondingly lengthy periods of time and imposes loads on the milling tools, such that they wear out more rapidly and must be replaced. In addition, the knowledge and technical skills of dental technicians can no longer be put to use, or only poorly, if all the modelling steps take place exclusively on computers in order to produce the CAD model.

The object of the invention is therefore to overcome the disadvantages of the prior art. In particular, a method is to be provided with which an elaborate and time-intensive processing with milling techniques can be avoided. As well as this, the wear on the milling tools is to be reduced and more rapid manufacture achieved.

In addition to this, it is intended that the simplest, most complete, and most economical possible manufacture of the wax base, the prosthesis base, and the dental prosthesis should be achieved. It is a further object of the invention to present a way with which the known methods of dental prosthesis manufacture can be combined as well as possible with modern production processes, in order that the existing know-how with regard to the conventional manufacture of dental prostheses can also be put to use in combination with modern CAD/CAM methods. By way of the invention, it is also intended that a wax base, a prosthesis base, a wax set-up, and a finished dental prosthesis should be provided. In addition, according to the invention, it should also be possible for substructures such as implants, bars, anchoring devices, and/or securing means for securing a hybrid prosthesis to such implants, bars, and/or anchoring devices to be integrated in the manufacture, or for these to be taken into account.

The objects of the invention are solved by a method for manufacturing a wax base or a prosthesis base for manufacturing a dental prosthesis with which a virtual CAD model of the dental prosthesis is used for the manufacture of the physical dental prosthesis or the physical prosthesis base, wherein, from the CAD model of the dental prosthesis, a virtual model of the prosthesis base is calculated, characterized by the following chronological steps:

A) Scanning in of at least one three-dimensional region of a physical model of the oral cavity situation of a patient and preparation of a data record D1 on the basis of this scan, or

intra-oral scan of a three-dimensional region of the oral cavity situation of the patient and production of a physical model of the oral cavity situation of a patient on the basis of the intra-oral scan and preparation of a data record D1 on the basis of the intra-oral scan;

B) application of a wax layer or a plastic layer onto the physical model of the oral cavity situation;

D) calculation of a virtual surface as a surface which is to be formed in the wax layer or in the plastic layer, wherein the calculation is made on the basis of the virtual model of the prosthesis base and of the data record D1, and wherein positioning aids are provided in the surface which is to be produced, for the positioning of prosthetic teeth; and

E) production of the wax base from the wax layer or of the prosthesis base from the plastic layer with a subtractive CAM method, on the basis of the virtual surface calculated in step D).

A scan or intra-oral scan in the meaning of the present invention is in this situation a 3D image of the scanned surface. The scan or intra-oral scan can, for example, be carried out by means of a stereo image with a stereo camera.

The physical model of the oral cavity situation comprises preferably a model of the upper jaw and of the lower jaw, as well as the relationship between the two models to one another. The method can also be carried out with a physical model of the oral cavity situation, however, which contains only a model of the upper jaw or lower jaw or parts thereof.

The virtual CAD model of the dental prosthesis is preferably produced in that a physical model pair of the oral cavity situation of the upper jaw and of the lower jaw and their relationship to one another, or the upper jaw and the lower jaw of the oral cavity situation and their relationship to one another, is scanned in or measured, and then, with CAD software, the dental prosthesis is designed as a virtual CAD model. From the virtual CAD model of the dental prosthesis, by computed separation, a data record for the prosthetic teeth and a data record for the prosthesis base are produced. The latter data record for the prosthesis base is then the virtual model of the prosthesis base. The virtual model of the prosthesis base can then be used to produce a physical prosthesis base made of wax or plastic.

According to the invention, it can preferably be provided that the wax layer or the plastic layer exhibits a thickness of at least 3 mm, preferably a thickness of between 5 mm and 15 mm, and particularly preferably between 8 mm and 12 mm.

With the invention, a step C) is also proposed, which takes place between the steps B) and D):

C) Scanning in of at least one region of the physical model, with the wax layer or the plastic layer applied, of the oral cavity situation and production of a second data record D2 on the basis of this scan.

As a result, the difference between the non-layered and the layered model of the oral cavity can be used for the controlling of the CAM process in step E), and/or for the calculation of the virtual surface in step D).

In this situation, it can be provided that in step C) the free surface of the wax layer or the plastic layer on the physical model of the oral cavity is scanned in at least in some areas, and the scan is processed to form the second data record D2, wherein the calculation of the virtual surface as the surface which is to be produced in the wax layer or in the plastic layer on the basis of the CAD model of the prosthesis base, takes place on the basis of the first data record D1 and on the basis of the second data record D2.

As a result of this, the surface of the wax layer or the plastic layer is known, such that, during the following subtractive CAM process, material is only removed, or only needs to be removed, in the areas in which there really is material (wax or plastic) present to be removed. This therefore allows for manufacture to be speeded up, since from the virtual models of the wax layer or the plastic layer it is known at which points wax or plastic is present. Preferably, a part of the physical model of the oral cavity is also scanned in at the same time, in order to determine and ensure the exact positioning of the wax or plastic layer on the physical model of the oral cavity.

According to a preferred further embodiment of the method according to the invention, it can be provided that the surface which is produced in the wax layer or the plastic layer lies opposite the contact surface of the wax layer or the plastic layer on the physical model of the oral cavity.

Accordingly, the calculation and production of the surface can be restricted to the main and accessible parts.

It can further be provided that the positioning aids exhibit an unmistakable shape in such a way that the location and the position of the prosthetic teeth in relation to one another is unmistakably defined when the prosthetic teeth are inserted with flush surfaces into the positioning aids of the prosthesis base, or if the prosthetic teeth are inserted with flush surfaces into the positioning aids of the wax base.

Preferably it can be provided according to the invention that the positioning aids are configured as tooth sockets. Tooth sockets are indentations in the prosthesis base or the wax base with a form and shape which is matched to receive the prosthetic teeth. For this purpose, the tooth sockets are particularly preferred to have, in addition to a base, also a circumferential wall. The prosthetic teeth are then simply adhesively bonded basally into the wax prosthesis, or basally into the prosthesis base.

As positioning aids, as an alternative to tooth sockets, elevations can also be provided on the wax base or the prosthesis base, onto which the prosthetic teeth are placed. Such elevations for the realizing of the positioning aids can be produced, for example by cylindrical elevations, in the manner such as are provided on Lego® bricks (Lego® brick principle). The elevations and the positioning aids respectively can, however, preferably also exhibit a symmetry which is not rotationally symmetrical, in order to allow for a distinctly specific axial positioning of the prosthetic teeth. For this purpose, the size and height of the elevations or, more generally, the shape and form of the positioning aids (even if there are no elevations) can be distinct and specific for each prosthetic tooth, in order to ensure a specific positioning and alignment of the prosthetic teeth.

By means of specifically formed and shaped positioning aids, a specific positioning of the prosthetic teeth can be ensured, such that the risk of erroneous placement of the prosthetic teeth will be reduced or avoided. This pre-empts an erroneous production of the dental prosthesis. Preferably, the wax base or the prosthesis base is located on the physical model of the oral cavity situation, while the prosthetic teeth are inserted into the positioning aids.

Particularly preferred embodiments of the present invention can provide for the production of the wax base from the wax layer or the production of the prosthesis base from the plastic layer with a subtractive CAM method, while the wax layer or the plastic layer is arranged on the physical model of the oral cavity.

The underlay which the physical model of the oral cavity provides can be particularly well used for the stabilizing and positioning of the wax base or the prosthesis base during the processing.

It is preferred according to the invention if, during the scanning in of the at least one area of the physical model of the oral cavity situation in step A), at least the surfaces are scanned onto which the wax layer or the plastic layer is subsequently applied, or, during the intra-oral scan of the oral cavity situation of the patient in step A), at least the surfaces are scanned onto which the wax layer or the plastic layer is applied with the physical model.

As a result, it will be ensured that the entire underside or contact surface respectively of the wax layer or the plastic layer is known when the subsequent calculations are carried out.

In addition, for the standardization, reproducibility, and simplification of the method it can be provided that the application of the wax layer or the plastic layer onto the physical model of the oral cavity situation is carried out with the aid of preformed wax bodies, in particular with the aid of at least one wax plate, or with the aid of soft preformed plastic bodies, in particular with the aid of at least one plastic plate, and/or a molding spoon is used for the application on the physical model of the oral cavity.

The wax or the plastic can be softened beforehand, for example by heating. The term ‘soft plastic plate’ or a ‘soft plastic body’ is understood to mean those of which the plastic deformability is sufficient that, under the manual imposition of force, the plastic can be pressed to the desired surface of the physical model of the oral cavity situation. For this purpose, simple tools can be used. Preferably, a plurality of molding spoons can be used, which match the different types and different size ranges of oral cavity situations, in order to apply the wax layer or the plastic layer on the physical model of the oral cavity situation.

As a result, the process of application can be made much simpler for the user. In addition, possible errors in the layering, such as could be caused by gaps or poor connections, can be better prevented.

In one further embodiment, it is proposed that the physical model of the oral cavity, before step A), be acquired by way of an impression of the upper jaw and/or an impression of the upper jaw in the oral cavity of the patient, wherein preferably the impression is cast with gypsum plaster or a plastic, in order to produce a gypsum model or a plastic model as a physical model of the oral cavity situation.

As a result, tried and trusted methods can be put to use in order to implement the method according to the invention. Preferably, a model pair (upper jaw and lower jaw) is produced from gypsum plaster, in relation to one another as a physical model of the oral cavity situation. The relationship of the model pair can in this case be adjusted by the use of an articulator.

Particularly advantageous are methods according to the invention in which it is provided that the virtual CAD model of the dental prosthesis and/or the virtual model of the prosthesis base is produced on the basis of the data record D1 of the scan of the physical model of the oral cavity situation or of the intra-oral scan of the oral cavity situation by a CAD process.

In the former case, the physical model of the oral cavity situation which is in any event provided and used for the method is also used simultaneously for the calculation of the virtual model of the dental prostheses. In addition, in this way deviations can be avoided between the virtual CAD model of the dental prosthesis and the wax base or prosthesis base which is to be produced.

It can further be provided that a computer-controlled milling machine be used for the implementation of the subtractive CAM process, preferably a computer-controlled 4-axis or 5-axis milling machine.

With these milling machines the method can be further automated and carried out rapidly.

If it is intended that a hybrid prosthesis made of plastic is to be prepared from the wax base or the prosthesis base, then it can be provided according to the invention that for the production of the wax base or the prosthesis base, at least one securing means is arranged at the physical model of the oral cavity situation, in particular at the points of the physical model of the oral cavity situation which correspond to the implants, or at least one securing means is secured to a rail and/or an anchoring device, which is or are arranged at the physical model of the oral cavity situation, in particular at the points of the physical model of the oral cavity situation which correspond to the implants, and next, in step B), the wax layer or the plastic layer is applied onto the physical model of the oral cavity situation in such a way that the wax layer or the plastic layer is connected to the at least one securing means.

In this way, the prosthesis base which is to be provided can be produced already connected to the at least one securing means. With the method according to the invention, therefore, a hybrid prosthesis can be manufactured. Implants, bars, or other anchoring devices for the dental prosthesis can therefore also be taken into account with the method according to the invention.

It can preferably also be provided that the scan of the physical model of the oral cavity situation or of the intra-oral scan with implants, with at least one bar fitted, and/or with at least one anchoring device, is carried out with at least one anchoring device on the physical model or in the oral cavity, and particularly preferably with at least one securing means secured to the implants, to the at least one inserted bar, and/or to the at least one anchoring device.

As a result, any substructures (implants, bars, anchoring devices, securing means) beneath the wax base or plastic base can be detected with the scan or the intra-oral scan, and then taken into account in the calculation of the virtual surface in step D).

The objects on which the present invention is based are also solved by a method for producing a dental prosthesis or a wax set-up for a dental prosthesis with a method according to the invention as described heretofore, but wherein, after step E), a step F) takes place:

F) Insertion of prosthetic teeth into the positioning aids of the wax base, which in step E) were produced in the surface of the wax layer, to produce the wax set-up, or inserting and securing, in particular by adhesive bonding, of prosthetic teeth into the positioning aids of the prosthesis base, which in step E) were produced in the surface of the plastic layer, for producing the dental prosthesis, wherein preferably the dental prosthesis is polished after the inserting and securing of the prosthetic teeth, and/or the connection of the prosthetic teeth to the prosthesis base is hardened.

As a result of this, the physical wax set-up and the physical dental prosthesis respectively can be produced in a simple manner.

In addition, the objects on which the present invention is based are also solved by a method for producing a dental prosthesis from a wax set-up, produced by such a method, wherein after step F) the wax set-up with the prosthetic teeth is cast into a mold, the wax of the wax base is removed, in particular by the melting of the wax and by the releasing of the wax with water vapor or steam, wherein the prosthetic teeth remain in the mold and the location and position of the prosthetic teeth in the mold remain unchanged, the cavity which is formed in the mold is filled with a plastic, which forms the prosthesis base of the dental prosthesis, the plastic is hardened, wherein the prosthetic teeth are securely connected to the plastic, the mold is opened, and the dental prosthesis is taken from the mold, wherein preferably the dental prosthesis, after removal from the mold, is subsequently processed by polishing and/or deburring.

As a result of this, the production methods which are conventionally used today in dental laboratories can be combined with modern computer-assisted processes, such that both the know-how of the dental technician which is already available as well as modern findings for optimizing the production of dental prostheses can be utilized.

The objects of the present invention are also solved by a wax base or prosthesis base produced with such a method and by a dental prosthesis produced with such a method.

The prosthetic teeth preferably consist of a plastic, particularly preferably of polymethyl methacrylate (PMMA).

The prosthetic teeth can be present individually and/or in a plurality of groups assembled together or as complete teeth rows. Prosthetic teeth assembled together are securely connected to one another.

The plastic for producing the prosthesis base consists preferably of a pink-colored plastic and the prosthetic teeth of a tooth-colored plastic.

The invention is based on the surprising finding that with the present invention it is possible for a material-saving method to be provided, with which a prosthesis base, a wax base, and, respectively a dental prosthesis, can be produced, wherein at the same time modern CAD/CAM methods can be used, such that, on the one hand, the advantages, such as automation, of CAD/CAM methods can be exploited, but at the same time a rapidly implemented and material-saving form of manufacture is provided, which also reduces wear on production tools. At the same time, the knowledge and craft skills available in dental laboratories can be advantageously put to use, in particular if the prosthetic teeth are first set up on a wax base, and the actual dental prosthesis is then prepared with a mold based on this, with the aid of a flask, or if the plastic layer or the wax layer are applied manually, with the skilled knowledge of a dental technician, who is capable of assessing at which points of the physical model of the oral cavity material is to be applied for the prosthesis base or wax base respectively, and at which points there should be no material present, and in what thickness material is most advantageously to be applied. With the invention the advantages are achieved, among others, that shorter milling times are necessary, that less material use as base material (wax or plastic respectively) is necessary, and that less wear is imposed on the milling tools (less were on the milling heads and on the drive). In addition to this, a greater number of prosthesis bases, wax bases, and dental prostheses can be manufactured in the same time, which incurs advantages given the high costs which a CAM milling procedure incurs in procurement. With the use of an intra-oral scan, the contact surface for the virtual model of the wax base or the plastic base can be acquired directly from the patient, or can be determined from such an image, such that the physical model of the oral cavity no longer needs to be scanned in, since it has already been produced from this data. This therefore avoids possible errors in the taking of an impression.

In addition, it is also possible for hybrid prostheses to be produced with the method according to the invention. Hybrid prostheses are dental prostheses which are connected to implants inserted into the jaw. For this purpose, bars can be connected to the implants, which remain connected to the implants, wherein the dental prosthesis can be connected to the bar by means of a plurality of clips as securing means. Other anchoring devices for the securing hybrid prostheses are conceivable and can be applied with the method according to the invention.

The solutions on which this invention is based are derived from the processing on one side only of the wax base or plastic base, which for particular preference is effected directly on the physical model of the oral cavity situation.

An exemplary method according to the invention can comprise the following method steps:

A) Scanning in a pure gypsum model as a physical model of the oral cavity situation of a patient. In this situation, the contact surface for the later dental prosthesis is of particular importance. It is not of relevance in this context whether the physical model represents exclusively the pure gum tissue, or encompasses the gum tissue and already integrated prosthetic elements, such as bars or implant set-ups. It is also possible for existing teeth to be represented in the physical model, wherein a part prosthesis is then produced as the dental prosthesis.

B) After the scanning in, a wax layer or plastic layer is adapted to the physical model. The wax layer or plastic layer should exhibit a thickness of at least 3 mm, but preferably some 10 mm.

C) The physical model of the oral cavity with the wax layer or plastic layer is now scanned in again. In this situation, the wax base is of particular importance. This step C) can also be omitted, but is advantageous, since in this way, in the subtractive CAM process which then follows, it is known where the surface of the wax layer or of the plastic layer begins, and therefore the milling head or the tool can be forthwith correctly controlled or forthwith brought into the correct position, in order to remove material. As a result, time can again be saved in the production of the wax base or the prosthesis base from plastic in the CAM device.

D) Next, by using suitable software, a comparison is carried out between the physical model without wax layer or plastic layer, and the model with wax layer or plastic layer. In addition, on the basis of a virtual model of the prosthesis base, the surface which is to be produced in the wax layer or the plastic layer is calculated. In this situation, the scan of the physical model of the oral cavity can be used as the underside or, respectively, as the contact surface for the virtual model of the dental prosthesis and therefore of the prosthesis base or the wax set-up (wax base with prosthetic teeth). Calculated into the virtual model of the prosthesis base are tooth sockets, as positioning aids for receiving pre-assembled prosthetic teeth. The difference between the virtual model of the prosthesis base and the scan of the physical model of the oral cavity with the wax layer or the plastic layer produces the volume body which is then to be removed with the CAM process (including the shape of the volume body). It is therefore also determined which area of the wax layer or the plastic layer is to be removed.

E) By means of milling elements, the wax layer or plastic layer is removed only on the upper side, corresponding to the patient's situation and the prosthetic teeth make-up. Any mechanical processing of the underside, towards the gum tissue, is entirely superfluous. The position calculated beforehand of the prosthetic teeth is then milled in accordingly.

F) The prosthetic teeth are inserted into the tooth sockets, or, respectively, the positioning aids are inserted. The finished wax base or dental prosthesis is removed from the physical model and used for trying out on the patient.

The method can be implemented in a similar manner if first the oral cavity situation is recorded from the patient with an intra-oral scan, and the physical model of the oral cavity situation is produced on the basis of this intra-oral scan. If appropriate, set-ups such as implants or bars, which are inserted in the oral cavity of the patient, are produced by the physical model, or the set-ups (in particular with the securing elements) are arranged at the physical model, in order to integrate them into the wax layer or plastic layer. For this purpose, it can also be advantageous if an additional scan of the physical model of the oral cavity situation is carried out with securing elements placed in position or secured, and then used as the data record D1.

Further exemplary embodiments of the invention are explained hereinafter on the basis of five schematically represented Figures, but without thereby restricting the invention. The Figures show:

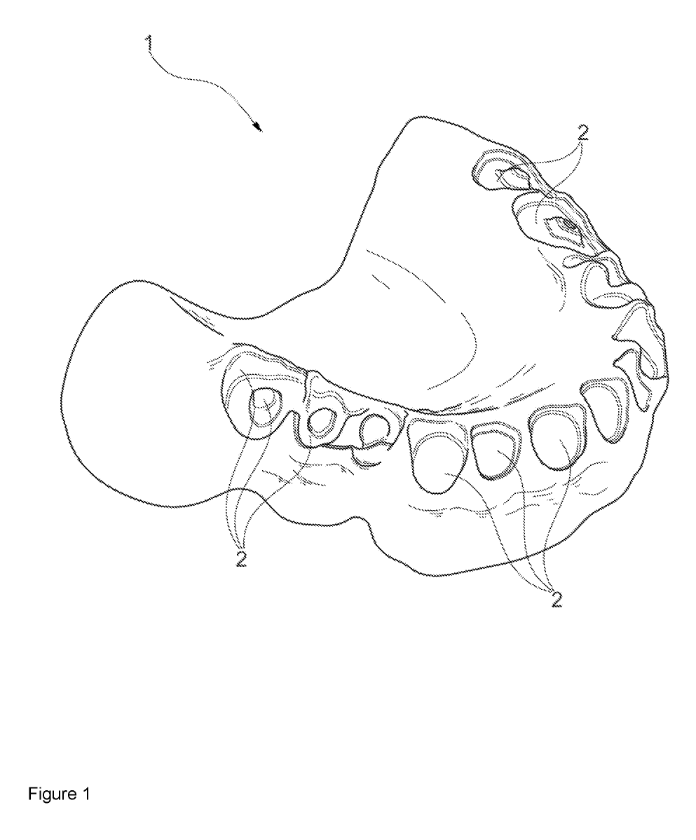

FIG. 1: A perspective view of a prosthesis base or wax base for a lower jaw without prosthetic teeth, such as derived from the virtual model of the prosthesis base and such as derived with the carrying out of a method according to the invention; and

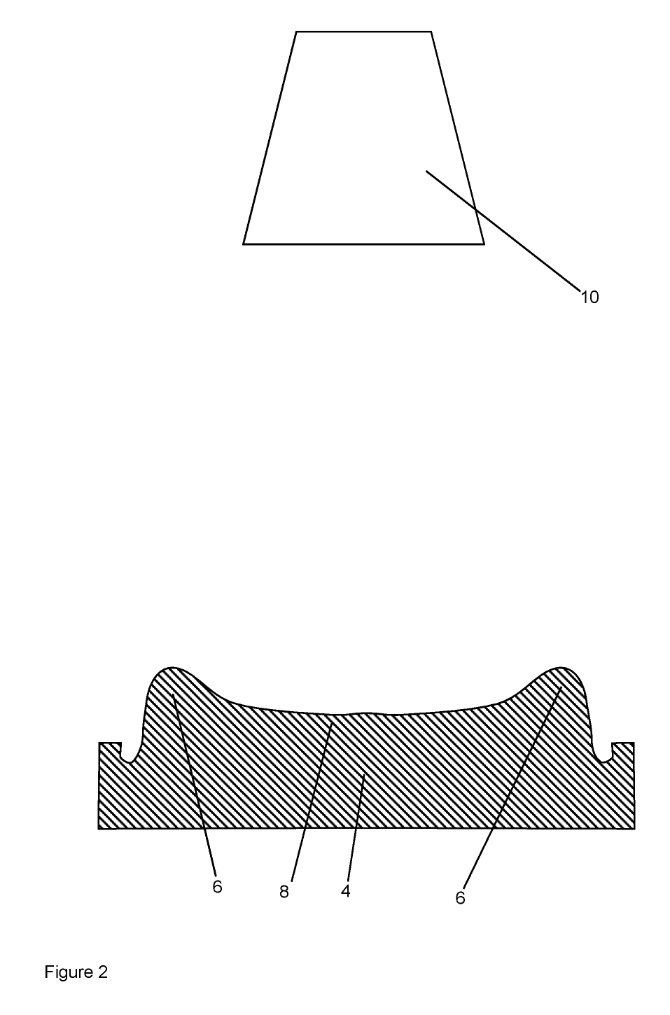

FIGS. 2 to 5: The chronological sequence of a method according to the invention, on the basis of a physical model oral cavity situation, set up on a prosthesis base or wax base and schematically represented in cross-section.

FIG. 1 shows a schematic perspective view of a wax base 1 or a prosthesis base 1 made of plastic with a method according to the invention and provided for producing a wax set-up according to the invention or a dental prosthesis according to the invention. Likewise represented in FIG. 1 can also be the virtual model of the prosthesis base. If the prosthesis base 1 is made of plastic, it consists of a pink-colored plastic. The coloring and transparency are selected such as to match the appearance of a gum.

Provided in the upper side of the wax base 1 or prosthesis base 1 are a plurality of tooth sockets 2 for the fixing of prosthetic teeth (not shown in FIG. 1). The tooth sockets 2 are in this situation formed as depressions in the jaw saddle of the wax base 1 or prosthesis base 1. The tooth sockets 2 can exhibit an indexing arrangement, such that the prosthetic teeth are to be inserted only in one specific orientation region in the wax base 1 or the prosthesis base 1, and, as far as possible, each prosthetic tooth fits only to one specific tooth socket 2.

The tooth sockets 2 exhibit in the indentations centrally arranged projections, which match with corresponding indentations in the basal ends of the prosthetic teeth (not shown in FIG. 1). As a result, it can be specified still more clearly and identifiably which prosthetic teeth should be inserted into which tooth sockets 2, and in what orientation the prosthetic teeth should be inserted into the tooth sockets 2. Specifically, with appropriate symmetry breaking, the elevations can serve as indexing elements. In addition, in this way a more stable connection of the wax base 1 or of the prosthesis base 1 to the prosthetic teeth can be produced. This is also of significance with regard to the wax base 1, since the prosthesis base produced later with the aid of the wax base has the same shape as the wax base 1, and, at the latest at the production of the prosthesis base, a stable connection to the prosthetic teeth is desirable at the production of the dental prosthesis.

FIGS. 2 to 5 show the chronological sequence of a method according to the invention on the basis of a physical model of the oral cavity situation, represented schematically in cross-section, onto which a prosthesis base or wax base, and later a wax set-up or a dental prosthesis are built up. The cross-section plane represented lies in a plane parallel to the frontal plane of the patient.

Represented in FIG. 2 is the scanning in of a physical model 4 of a toothless upper jaw of a patient. The physical model 4 was produced previously with the aid of an impression-taking compound and an impression tray, and filling of the shaped compound. Preferably, the shaped impression-taking compound is filled with gypsum plaster, such that a plaster model 4 is obtained. In the physical model 4, the jaw arch 6 and the jaw ridge 6 respectively, and the palate 8 of the oral cavity situation of the patient can be identified.

The physical model 4 is set up or fixed in a defined position, and then, with a scanner 10, the surface of the physical model 4 is recorded. For this purpose, the scanner 10 and/or the model 4 are moved relative to one another, such that all the relevant areas of the surface of the model 4, i.e. in particular the surfaces on which later the prosthesis base or the wax base, or, respectively, the dental prosthesis is intended to lie, can be recorded. The data D1 which is derived from the scan is stored.

As an alternative, the oral cavity situation of the patient can also be recorded with the aid of an intra-oral scan. The data record D1 is then calculated from the intra-oral scan, or determined on the basis of the scan. In this situation, it is also possible for evident errors in the model, which, for example, can be identified by the user graphically on a display screen, to be removed manually by the user. The data from the intra-oral scan is then additionally used in order to produce a virtual CAD model of the oral cavity situation and of a physical model 4 to be produced of the oral cavity situation. By means of a suitable CAM process, the physical model 4 of the oral cavity situation is then produced generatively or subtractively.

The data D1, regardless of whether acquired on the basis of a scan of the model 4 or on the basis of the intra-oral scan, can then be used to produce the virtual model of the dental prosthesis which is to be formed, using a CAD process. For this purpose, the data of a physical model of the lower jaw (not shown in the FIGS. 2 to 5), data regarding the articulation of the upper jaw and of the lower jaw of the patient, and data regarding the shape of prosthetic teeth to be inserted (i.e. virtual models of prosthetic teeth) are required and used. By calculated drawing off, or calculated separation of the molds of the prosthetic teeth from the CAD model, a virtual model of the prosthesis base is obtained.

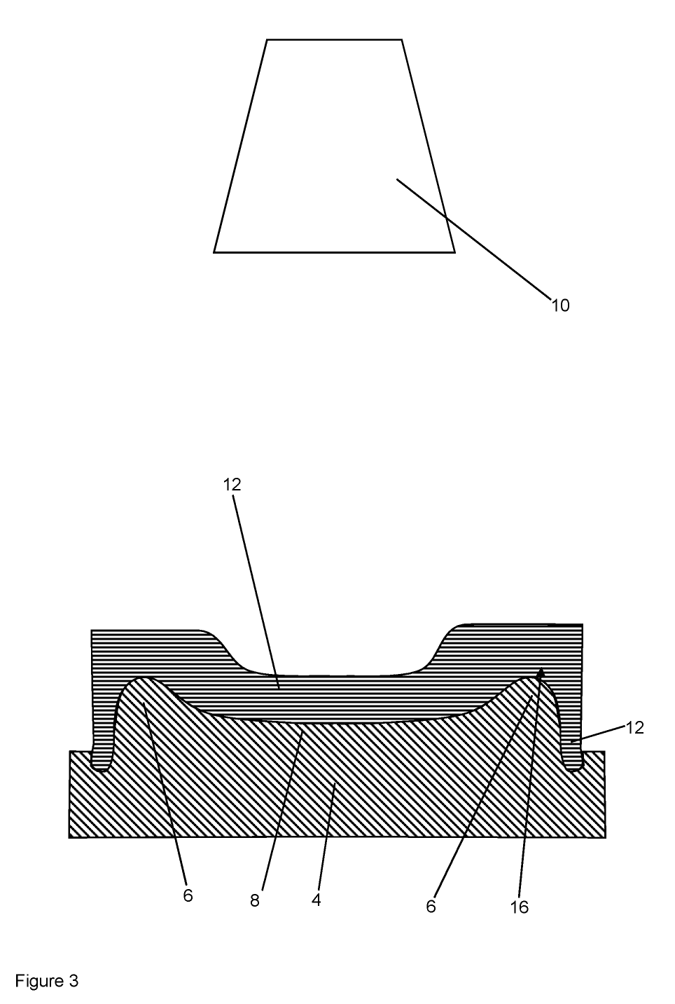

Next, a wax layer 12 or a plastic layer 12 is applied onto the physical model 4; that is to say, a base plate 12 of wax or plastic is adapted on the physical model 4. This is represented in FIG. 3. The wax layer 12 or plastic layer 12 has a thickness of 10 mm and is therefore in any event thicker than the wax base 1 or prosthesis base 1 to be produced, at its thickest point. This therefore ensures that later no material is missing at any point of the wax base 1 or prosthesis base 1 which is to be produced.

The wax layer 12 or the plastic layer 12 lies on the jaw arch 6 or jaw ridge 6 and the palate 8 of the physical model 4 of the oral cavity, which then specifies for the user the relevant anatomical structures of the oral cavity of the patient. The physical model 4 holds the layer 12 stable, and later also the wax base 1 or prosthesis base 1 to be produced from it. To produce a prosthesis base for the lower jaw, a corresponding model (not shown) of the lower jaw is used.

With the scanner 10, the surface of the model 4, with the wax layer 12 or plastic layer 12, is then scanned onto this (represented in FIG. 3). In this situation, the entire surface of the wax layer 12 or plastic layer 12 is recorded, which lies opposite the contact surface on the physical model 4. This scan is stored as a data record D2.

From the data D1 of the surface of the physical model 4, the virtual model of the prosthesis base and the data D2 of the surface of the wax layer 12 or the plastic layer 12 on the physical model 4, it is then calculated how much material (wax or plastic) and at what points the material must be removed from the wax layer 12 or plastic layer 12, and this result is stored as a data record D3.

Based on the data D3, with a computer-controlled milling device 14 (such as a computer-controlled 4-axis or 5-axis milling device), the wax layer 12 or plastic layer 12 is processed or milled while it is still lying on the physical model 4. For this purpose, the physical model 4 of the oral cavity situation and the wax layer 12 or plastic layer 12 are secured on a mounting (not shown) of the milling device 14 and fixed.

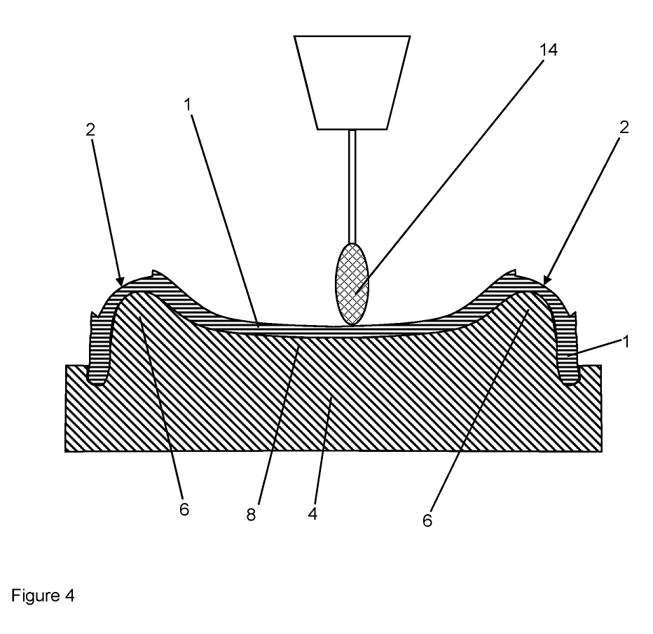

Processing in a very advanced state is represented in FIG. 4. As well as the desired shape of the wax base 1 or prosthesis base 1 of plastic produced in this way, tooth sockets 2 are also produced in the wax base 1 or prosthesis base 1. Such a completed wax base 1 or prosthesis base 1 with the tooth sockets 2 is represented in FIG. 1. The surface lying on the physical model 4 of the oral cavity does not need to be processed with the milling device, and therefore remains very smooth.

If appropriate, polishing can be applied on this side. As a result, there is no requirement for processing of one side of the prosthesis base 1 or the wax base 1 respectively, which can save a considerable amount of time.

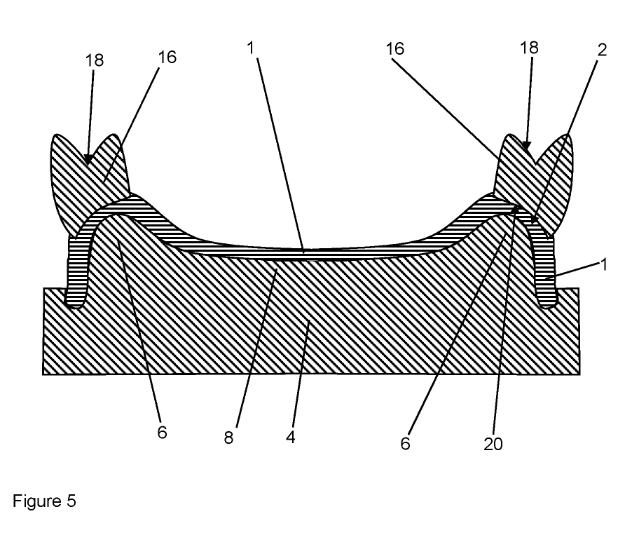

In a next step, prosthetic teeth 16 are inserted into the tooth sockets 2 and then secured. This is represented in FIG. 5.

The cut prosthetic teeth 16 are configured here as molars or posterior or buccal teeth prostheses. The prosthetic teeth 16 consist of a hard white plastic, with the appropriate coloring and transparency to match teeth, or specifically the teeth of the patient. Each prosthetic tooth 16 comprises a coronal or occlusal surface 18 respectively (chewing surface) and a basal surface 20. The basal surface 20 is fixed in the tooth sockets 2.

The tooth sockets 2 are the basal counter-pieces of the basal sides 20 of the prosthetic teeth 16. Before the first insertion of the prosthetic teeth 16 into the tooth sockets 2 in the prosthesis base 1 of plastic, the tooth sockets 2 and the prosthetic teeth 16 (at least the basal sides 20 of the prosthetic teeth 16) are cleaned and, in order to improve the connection, are roughened and swelled with a solvent, and then connected with an adhesive.

Surplus residues of adhesive which emerged due to squeezing can be removed before and/or after hardening.

The completed dental prosthesis or the wax set-up can then be inserted in the patient's mouth for checking the fit. The wax set-up (wax base 1 with prosthetic teeth 12 inserted) offers still further possibilities for correction by the dental technician and/or the dentist. Based on the wax set-up, using known methods, with the aid of a flask as a mold, and by removing the wax from the mold, a dental prosthesis is produced, in that the cavity with the prosthetic teeth 12 fixed in it is filled with plastic and connected to the prosthetic teeth 12. Subsequent processing of the finished dental prosthesis (polishing and deburring) can then take place.

The method according to the invention can also be applied to printed prosthetic teeth or prosthetic teeth rows, but is preferably carried out with pre-assembled prosthetic teeth, which can be basally shortened beforehand, manually or with an automatic milling process.

The features of the invention disclosed in the foregoing description, as well as in the claims, Figures, and exemplary embodiments, can be essential individually as well as in any desired combination for the realization of the invention in its various different forms.

### REFERENCE NUMBER LIST

1 Wax base/prosthesis base

2 Tooth socket for the fixing of prosthetic teeth

4 Physical model of the upper jaw/oral cavity

6 Jaw arch/jaw ridge of the model of the oral cavity

8 Palate of the model of the oral cavity

10 Scanner

12 Wax layer/plastic layer

14 Milling device/milling head

16 Prosthetic tooth

18 Coronal surface of the prosthetic tooth

20 Basal surface/basal side of the prosthetic tooth

1. Method for producing a wax base or a prosthesis base for producing a dental prosthesis, with which a virtual CAD model of the dental prosthesis is used for producing the physical dental prosthesis or the physical prosthesis base, wherein, from the CAD model of the dental prosthesis, a virtual model of the prosthesis base is calculated, the method comprising the following chronological steps:
A) scanning at least one three-dimensional region of a physical model of an oral cavity situation of a patient and preparing a first data record D1 on the basis of this scan, or
intra-oral scanning a three-dimensional region of the oral cavity situation of the patient and producing a physical model of the oral cavity situation of the patient on the basis of the intra-oral scan and preparing a first data record D1 on the basis of the intra-oral scan;
B) applying a wax layer or a plastic layer onto the physical model of the oral cavity situation;
D) calculating a virtual surface as a surface which is to be formed in the wax layer or in the plastic layer, wherein the calculation is made on the basis of the virtual model of the prosthesis base and of the first data record D1, and wherein positioning aids are provided in the surface which is to be produced, for the positioning of prosthetic teeth; and
E) producing the wax base from the wax layer or of the prosthesis base from the plastic layer with a subtractive CAM method, on the basis of the virtual surface calculated in step D).

2. Method according to claim 1, further comprising a step C), which takes place between steps B) and D):
C) scanning at least one region of the physical model, with the wax layer or the plastic layer applied, of the oral cavity situation and producing a second data record D2 on the basis of this scan.

3. Method according to claim 2, comprising in step C), scanning the free surface of the wax layer or the plastic layer in at least some regions on the physical model of the oral cavity, and processing the scan to the second data record D2, wherein a calculation of the virtual surface, as the surface to be produced, takes place in the wax layer or in the plastic layer, on the basis of the CAD model of the prosthesis base, on the basis of the first data record D1, and on the basis of the second data record D2.

4. Method according to claim 1, comprising locating the surface which is produced in the wax layer or the plastic layer opposite the contact surface of the wax layer or the plastic layer on the physical model of the oral cavity.

5. Method according to claim 1, wherein the positioning aids exhibit a distinctive form, in such a way that the location and the position of the prosthetic teeth in relation to one another is distinctively and unambiguously determined when the prosthetic teeth are inserted with flush surfaces into the positioning aids of the prosthesis base or when the prosthetic teeth are inserted with flush surfaces into the positioning aids of the wax base.

6. Method according to claim 1, comprising producing the wax base from the wax layer or the prosthesis base from the plastic layer with a subtractive CAM method, while the wax layer or the plastic layer is arranged on the physical model of the oral cavity.

7. Method according to claim 1, comprising scanning at least those surfaces onto which the wax layer or the plastic layer are subsequently applied in respect of the physical model.

8. Method according to claim 1, comprising applying the wax layer or the plastic layer onto the physical model of the oral cavity situation with the aid of preformed wax bodies or with the aid of soft preformed plastic bodies.

9. Method according to claim 1, comprising acquiring the physical model of the oral cavity before step A) by an impression of the upper jaw and/or an impression of the upper jaw in the oral cavity of the patient.

10. Method according to claim 1, comprising producing the virtual CAD model of the dental prosthesis and/or the virtual model of the prosthesis base on the basis of the data record D1 of the scan of the physical model of the oral cavity situation or of the intra-oral scan of the oral cavity situation, by a CAD process.

11. Method according to claim 1, comprising using a computer-controlled milling device to implement the subtractive CAM process.

12. Method according to claim 1, comprising,
for producing the wax base or the prosthesis base, arranging at least one securing means at the physical model of the oral cavity situation, or securing at least one securing means to a rail and/or an anchoring device, which is/are arranged at the physical model of the oral cavity situation, and,
following this, in step B), applying the wax layer or the plastic layer onto the physical model of the oral cavity situation in such a way that the wax layer or the plastic layer is connected to the at least one securing means.

13. Method according to claim 12, comprising carrying out the scan of the physical model of the oral cavity situation or the intra-oral scan with implants with at least one web inserted, and/or with at least one anchoring device at the physical model or in the oral cavity.

14. Method for producing a dental prosthesis or a wax set-up for a dental prosthesis with a method according to claim 1, comprising, after step E):
F) inserting prosthetic teeth into the positioning aids of the wax base, which in step E) were produced in the surface of the wax layer for producing the wax set-up, or inserting and securing prosthetic teeth into the positioning aids of the prosthesis base, which in step E) were produced in the surface of the plastic layer for producing the dental prosthesis.

15. Method for producing a dental prosthesis from a wax set-up produced with a method according to claim 14, comprising:
after step F), casting the wax set-up with the prosthetic teeth into a mold,
removing the wax of the wax base is removed, wherein the prosthetic teeth remain in the mold, and the location and position of the prosthetic teeth in the mouth remain unchanged,
casting the cavity which is created in the mold with a plastic, which forms the prosthesis base of the dental prostheses,
hardening the plastic, whereby the prosthetic teeth are securely connected to the plastic, and,
opening the mold and removing the dental prosthesis from the mold.

16. Wax base or prosthesis base produced with a method according to claim 1.

17. Dental prosthesis produced with a method according to claim 14.

18. Dental prosthesis produced with a method according to claim 15.

19. Method according to claim 8, comprising applying the wax layer or the plastic layer onto the physical model of the oral cavity situation with the aid of at least one wax plate, or with the aid of at least one plastic plate and/or a molding spoon.

20. Method according to claim 9, wherein the impression is cast with gypsum plaster or a plastic to produce a gypsum model or a plastic model as a physical model of the oral cavity situation.

21. Method according to claim 11, comprising using a computer-controlled 4-axis or 5-axis milling device to implement the subtractive CAM process.

22. Method according to claim 12, comprising,
for producing the wax base or the prosthesis base, arranging at least one securing means at the physical model of the oral cavity situation at points of the physical model of the oral cavity situation which correspond to the implants, or securing at least one securing means to a rail and/or an anchoring device, which is/are arranged at the physical model of the oral cavity situation at points of the physical model of the oral cavity situation which correspond to the implants, and,
following this, in step B), applying the wax layer or the plastic layer onto the physical model of the oral cavity situation in such a way that the wax layer or the plastic layer is connected to the at least one securing means.

23. Method according to claim 13, comprising carrying out the scan of the physical model of the oral cavity situation or the intra-oral scan with implants with at least one web inserted, and/or with at least one anchoring device at the physical model or in the oral cavity with at least one securing means secured to the implants, to the at least one inserted web, and/or to the at least one anchoring device.

24. Method for producing a dental prosthesis or a wax set-up for a dental prosthesis with a method according to claim 14, wherein step F comprises inserting and adhesive bonding in place, the prosthetic teeth into the positioning aids of the prosthesis base.

25. Method for producing a dental prosthesis or a wax set-up for a dental prosthesis with a method according to claim 14, comprising, after inserting and securing the prosthetic teeth, polishing the dental prosthesis and/or hardening the connection of the prosthetic teeth to the prosthesis base.

26. Method for producing a dental prosthesis from a wax set-up produced with a method according to claim 15, comprising removing the wax of the wax base is removed by melting the wax and by releasing the wax with water vapor or steam.

27. Method for producing a dental prosthesis from a wax set-up produced with a method according to claim 15, comprising opening the mold and removing the dental prosthesis from the mold and processing the dental prosthesis after removal from the mold by polishing and/or deburring.
